(19) United States
(12) Patent Application Publication
(10) Pub. No.: US 2025/0008031 A1
(43) Pub. Date: Jan. 2, 2025

(54) DEVICE MANAGEMENT SYSTEM AND CONTROL METHOD THEREOF

(71) Applicant: CANON KABUSHIKI KAISHA, Tokyo (JP)

(72) Inventor: TAISHI TOMIHISA, Kanagawa (JP)

(21) Appl. No.: 18/757,242

(22) Filed: Jun. 27, 2024

(30) Foreign Application Priority Data
Jun. 29, 2023 (JP) 2023-107292

(51) Int. Cl. H04N 1/00

(52) U.S. Cl. CPC H04N 1/00344; H04N 1/00079

(57) ABSTRACT

A device management system for managing a network device includes a memory storing instructions; and a processor executing the instructions causing the device management system to provide data generated on the basis of maintenance information including operation information collected from the network device serving as a service target and provide a simulation result of simulating effect of introduction of a service for managing the network device. When a setting value of the service for use in simulation is designated, the simulation result based on the setting value is provided.

### BACKGROUND

### Field

The present disclosure relates to a device management system and a control method thereof.

### Description of the Related Art

It is common to enter into a maintenance contract for providing periodic maintenance and repair support for an image forming device and request a maintenance service provider to perform the maintenance. A server on the cloud manages and analyzes data such as operation information of the image forming device connected via the Internet to improve the efficiency of maintenance service business. Japanese Patent Laid-Open No. 2022-121807 discloses a method of analyzing operation history information and proposing an improvement measure to increase the productivity of an image forming device whose productivity has deteriorated.

Here, an index (data) desired to be confirmed according to the role of the administrator, manager, and on-site personnel of the maintenance service provider is different with respect to the data collected for maintenance service business. Moreover, when a new service for device management to improve the operational efficiency of maintenance service work is introduced, it is difficult to ascertain the effect of introduction of the service.

### SUMMARY

The present disclosure provides a screen for enabling the effect of introduction of a service for managing a network device to be confirmed.

According to the present disclosure, there is provided a device management system for managing a network device, the device management system includes a memory storing instructions, and a processor executing the instructions causing the device management system to provide data generated on the basis of maintenance information including operation information collected from the network device serving as a service target, and provide a simulation result of simulating effect of introduction of a service for managing the network device, wherein, when a setting value of the service for use in simulation is designated, the simulation result based on the setting value is provided

Further features of the present disclosure will become apparent from the following description of exemplary embodiments with reference to the attached drawings.

### BRIEF DESCRIPTION OF THE DRAWINGS

FIG. 1 is a diagram showing a configuration of a device management system.

FIGS. 2A and 2B are diagrams showing a configuration of hardware of the device management system and a host computer.

FIG. 3 is a diagram showing a configuration of hardware of a printing device.

FIG. 4 is a diagram showing a configuration of software of the device management system.

FIG. 5 is a sequence diagram showing a flow of a process of displaying a dashboard screen.

FIG. 6 is a flowchart showing a maintenance information update process.

FIG. 7 is a flowchart showing a dashboard display process.

FIG. 8 is a flowchart showing a service introduction simulation process in Embodiment 1.

FIG. 9 is a diagram showing an example of an administration dashboard screen.

FIG. 10 is a diagram showing an example of the administration dashboard screen in which a simulation result is reflected.

FIG. 11 is a diagram showing an example of a management dashboard screen.

FIG. 12 is a diagram showing an example of the management dashboard screen in which a simulation result is reflected.

FIG. 13 is a diagram showing an example of a list for describing the handling of index values.

FIG. 14 is a diagram showing an example of a simulation setting screen when devices to which a service has been introduced and devices to which a service has not been introduced are mixed.

FIG. 15 is a flowchart showing a service introduction simulation process in Embodiment 2.

FIG. 16 is a flowchart showing a setting value change simulation process in Embodiment 2.

FIG. 17 is a diagram showing an example of the setting value simulation screen in Embodiment 2.

### DESCRIPTION OF THE EMBODIMENTS

### Embodiment 1

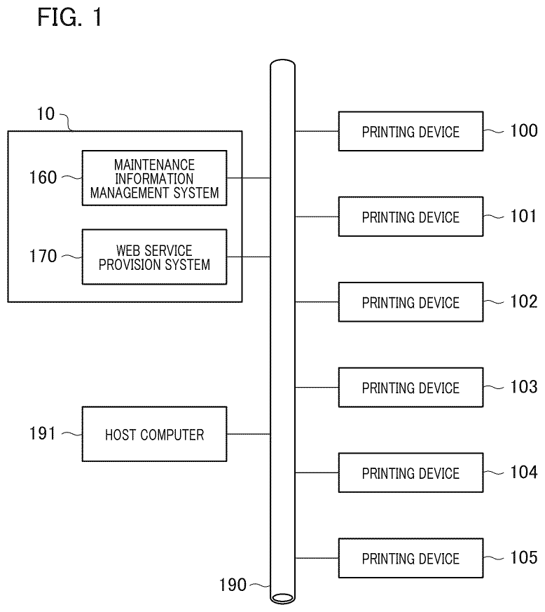

FIG. 1 is a diagram showing a configuration of a device management system. A device management system 10 provides a service for managing network devices. The device management system includes a maintenance information management system 160 and a web service provision system 170. Moreover, the device management system 10 may include management target network devices and a host computer 191 configured to display screens provided by the maintenance information management system 160 and the web service provision system 170 and perform an input to the screen. Printing devices 100 to 105 are management target network devices in the present embodiment. They are communicatively connected to each other through a network 190. A plurality of printing devices and a host computer may be connected and other devices may be connected.

The network device to be managed by the device management system 10 is a device capable of communicating with the device management system 10. In the present embodiment, the printing devices 100 to 105, which are image forming devices, will be described as examples. The printing devices 100 to 105 are examples of network devices to be managed by the device management system. In the present embodiment, a multifunction printer (MFP) in which a plurality of functions such as a printing function, a reading function, and a fax function are integrated used as the printing devices 100 to 105 will be described. In addition, each of the printing devices 100 to 105 may be a printer, a scanner device, a 3D printer, or the like.

The maintenance information management system 160 provides services related to maintenance of the printing devices 100 to 105. For example, operation information including error information such as failures of the printing devices 100 to 105, dispatch information of a serviceman related to a maintenance service, and inventory information of consumables are collected. Also, a request for the dispatch of a serviceman or an instruction for the delivery of consumables when repairs are required is issued on the basis of the collected information. The maintenance information management system 160 is realized, for example, by a single server.

The web service provision system 170 provides various types of services such as a device management service and a billing information management service for a printing device. Here, it is assumed that the device management service provides a web application that operates in a web browser such as the host computer 191. For example, the device management service provides data necessary for the device management service in response to a request of a client application dedicated to the device management service operating on the host computer 191. The screen provided by the web service provision system 170, such as the management dashboard screen to be described below, as the device management service is displayed on the display of the host computer 191 via the web browser. The web service provision system 170 is realized, for example, by a single server.

Although an example in which each of the maintenance information management system 160 and the web service provision system 170 includes various types of servers has been described in the present embodiment, the present disclosure is not limited thereto. The maintenance information management system 160 and the web service provision system 170 may be implemented as one system. Therefore, the maintenance information management system 160 and the web service provision system 170 may be realized by a single server. Moreover, the maintenance information management system 160 may be realized by a virtual machine (cloud service) using resources provided by a data center including the information processing device in addition to one or more information processing devices, or a combination thereof. The web service provision system 170 may also be realized by a virtual machine (cloud service) using resources provided by a data center including the information processing device in addition to one or more information processing devices, or a combination thereof.

The host computer 191 is an information processing device such as a PC or a tablet. The host computer 191 displays a screen provided by the device management system 10 via the web browser. It is only necessary for the network 190 to have a configuration in which data transmission/reception is possible and any communication method may be used in the network 190. For example, the network 190 includes any one of a local area network (LAN), a wide area network (WAN), a cellular network such as a long-term evolution (LTE) network or a fifth generation (5G) network, a wireless network, a telephone circuit, and a dedicated digital circuit, or a combination thereof.

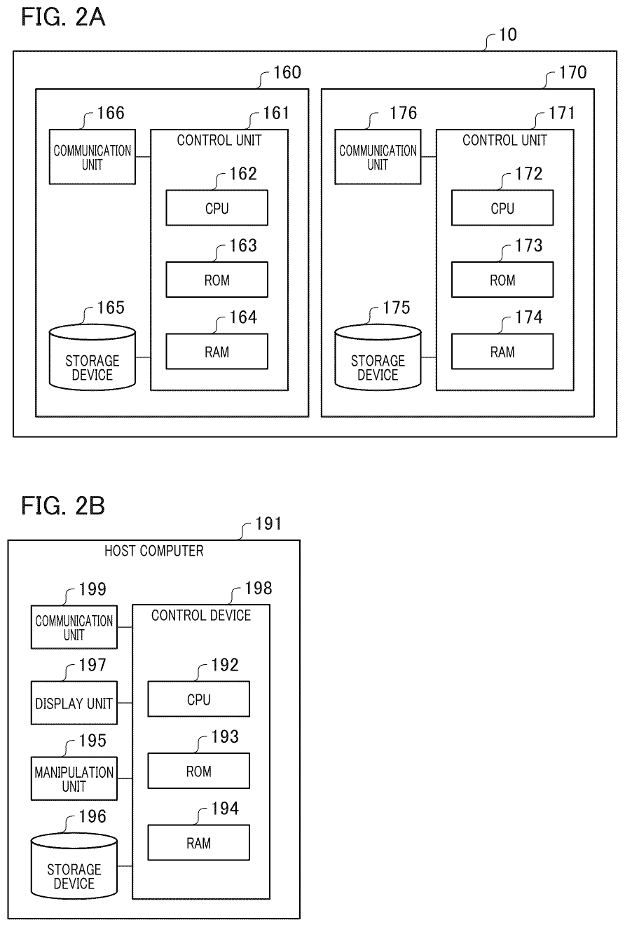

FIG. 2A is a diagram showing a configuration of hardware of the device management system 10. The device management system 10 includes a maintenance information management system 160 and a web service provision system 170. The maintenance information management system 160 includes a control unit 161, a storage device 165, and a communication unit 166. The control unit 161 is a control board (controller) that generally controls the maintenance information management system 160. The control unit 161 includes a central processing unit (CPU) 162, a read-only memory (ROM) 163, and a random-access memory (RAM) 164. The CPU 192 controls each block within the control unit 161 via a system bus (not shown). For example, the CPU 162 executes a function of the maintenance information management system 160 by reading and executing a program stored in the ROM 163, the RAM 164, the storage device 165, or another storage medium. For example, the ROM 163 stores various types of control programs including an operating system program (OS) and the like, tables and setting data necessary for executing the functions of the maintenance information management system 160, and the like. The RAM 164 is used, for example, as a work memory of the CPU 162. The storage device 165 stores, for example, device operation information, data, user information, device information, and the like collected from the printing devices 100 to 105. The communication unit 166 controls communication with an external device via the network 190.

The web service provision system 170 includes a control unit 171, a storage device 175, and a communication unit 176. The control unit 171 is a control board (controller) that generally controls the web service provision system 170. The control unit 171 includes a CPU 172, a ROM 173, and a RAM 174. The CPU 172 controls each block in the control unit 171 via a system bus (not shown). For example, the CPU 172 executes the function of the maintenance information management system 160 by reading and executing a program stored in the ROM 173, the RAM 174, the storage device 175, or another storage medium. The ROM 173, for example, stores various types of control programs including an operating system program (OS) and the like, tables and setting data necessary for executing the functions of the web service provision system 170, and the like. The RAM 174 is used, for example, as a work memory of the CPU 172. The storage device 175 stores, for example, device maintenance information acquired from the maintenance information management system 160, setting values and various types of data related to the display/generation of a dashboard, user information including user authentication information and authority information, device information, and the like. The communication unit 176 controls communication with an external device via the network 190.

FIG. 2B is a diagram showing a configuration of hardware of the host computer 191. The host computer 191 is an information processing device such as a PC. The host computer 191 displays a screen provided by the web service provision system via the web browser. The host computer 191 includes a control unit 198, a manipulation unit 195, a storage device 196, a display unit 197, and a communication unit 199. The control unit 198 is a control board (controller) that generally controls the host computer 191. The control unit 198 includes a CPU 192, a ROM 193, and a RAM 194. The CPU 192 controls each block in the control unit 198 via a system bus (not shown). For example, the CPU 192 executes the function of the host computer 191 by reading and executing a program stored in the ROM 193, the RAM 194, the storage device 196, or another storage medium. The ROM 193 stores, for example, various types of control programs including an operating system program (OS) and the like, tables and setting data necessary for executing the functions of the host computer 191, and the like. The RAM 194 is used, for example, as a work memory of the CPU 192. The storage device 196 stores, for example, various types of application programs, data, user information, device information, and the like. The manipulation unit 195 includes a keyboard, a pointing device, and the like for receiving a manipulation of a user and outputs information of the received manipulation of the user and the like to the control unit 198. The display unit 197 is, for example, a liquid crystal display, and displays various types of user interface screens and information. The communication unit 199 controls communication with an external device via the network 190.

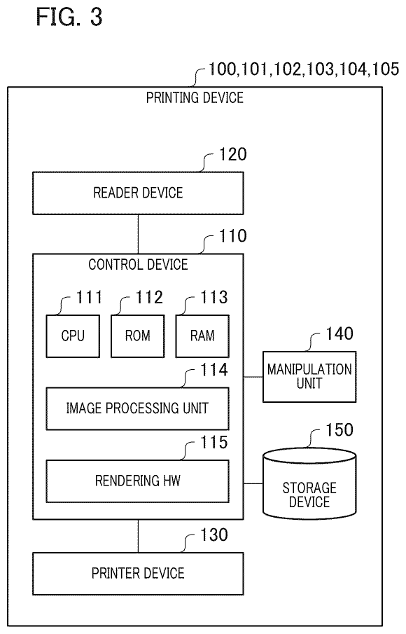

FIG. 3 is a diagram showing a configuration of hardware of the printing device 100. The printing device 100 includes a control unit 110, a reader unit 120, a printer unit 117, a manipulation unit 118, a storage device 119, and a communication unit 116. The control unit 110 is a control board (controller) that generally controls the printing device 100. The control unit 110 includes a CPU 111, a ROM 112, a RAM 113, an image processing unit 114, and rendering hardware (HW) 115. The CPU 111 controls each block in the control unit 110 via a system bus (not shown). The ROM 112 stores a control program, tables and setting data necessary for executing the functions of the printing device 100, and the like. The RAM 113 is used as a main memory of the CPU 111, a work area, or the like. The storage device 119 is a large-capacity memory such as a hard disk drive (HDD) or a solid-state drive (SSD). The HDD and the SSD store various programs and data, parameters, and the like. The storage device 119 stores, for example, image data, device information such as a mode and license, operation information such as the number of printed pages, user information such as an address book and customization, and the like. The CPU 111 executes the function of the printing device 100 by reading and executing a program stored in the memory (the ROM 112, the RAM 113, the storage device 119, or another storage medium connected to the printing device 100).

The image processing unit 114 performs various image processing such as conversion, correction, editing, and compression/decompression on electronic data generated by the reader unit 120 and externally received image data. The image processing unit 114 may include hardware or may be realized by software. The rendering HW 115 is hardware (HW) that performs a high-speed rendering process on the basis of intermediate data and generates a print output image.

The reader unit 120 optically reads a manuscript fed from a platen (not shown) or the automatic document feeder (ADF) and generates electronic data. The reader unit 120 has, for example, a configuration of a scanner engine. The printer unit 117 outputs image data returned from print data (for example, a page description language (PDL), a portable document format (PDF) language, or the like) to a paper medium or the like. Examples of a printing method executed by the printer unit 117 include an electrophotographic method (laser beam method), an inkjet method, a sublimation method (thermal transfer method), and the like. In the case of the electrophotographic method, the printer unit 117 includes consumable parts such as a developer, a drum, an intermediate transfer belt (ITB), a fixer, and a feed roller of a paper feed stage.

The manipulation unit 118 displays a screen and receives a manipulation instruction of the user via the screen. In the manipulation unit 118, a display unit such as a liquid crystal panel that displays an operation state of the image forming device and a setting screen (user interface screen) and a manipulation key for performing manipulations such as setting an operation mode of the image forming device and setting a copy process are arranged. In addition, a display unit and buttons may be realized as a touch panel on which a touch manipulation is possible using an electrostatic method, a pressure-sensitive method, or the like. By associating input coordinates and display coordinates in the touch panel, it is possible to configure a graphical user interface (GUI) as if the user can directly manipulate a screen displayed on the touch panel. The manipulation unit 118 outputs information of the received manipulation of the user and the like to the control unit 110. The communication unit 116 controls communication with an external device via the network 190.

In addition, the printing device 100 is not limited to the configuration shown in FIG. 1 and includes other configurations in accordance with executable functions of the printing device 100. For example, the printing device 100 may also include a configuration necessary for performing a fax function or a configuration that enables short-range wireless communication. Although an example in which the network device to be managed by the device management service is a printing device will be described in the present embodiment, the present disclosure is not limited thereto. For example, it is only necessary for the network device to be an information processing device such as a personal computer (PC), an image processing device such as a camera, or a device capable of communication serving as a device management service target such as a smart home appliance. The printing devices 101 to 105 also have configurations similar to that of the printing device 100.

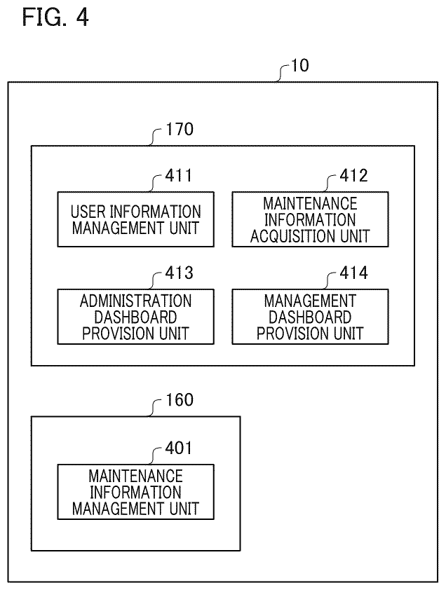

FIG. 4 is a diagram for describing a configuration of software of the device management system 10. The maintenance information management system 160 includes a maintenance information management unit 401. The maintenance information management unit 401 performs the management of maintenance information such as acquisition, processing, and storage of maintenance information. The maintenance information is information about maintenance of a management target device. The maintenance information includes information obtained by aggregating information acquired from the management target device, information acquired via a host computer, a mobile terminal, or the like, and collected information. Specifically, the information acquired from the management target device includes device information such as a serial number of the printing device, counter information for printing and scanning, degrees of wear and tear of parts, usage states of consumables, information about the replacement of parts and consumables, operation information of the device, error information, device setting values, and the like. Moreover, information acquired via other terminals includes information such as dispatch information, inventory information, and device management information. The dispatch information includes, for example, a dispatch date, a worker, a work time, a serial number of a printing device that is a dispatch target, a reason for dispatch, action content, and the like. The inventory information includes, for example, the number of toners or parts in inventory, a date of inventory confirmation, the number of orders, a date of ordering, an orderer, the number of uses, a date of use, a user, a serial number of a used printing device, and the like. The device management information includes a serial number of a printing device, model information, an installation location, information of a customer who owns the printing device, maintenance contract information, user information, and the like. Moreover, the maintenance information management unit 401 processes data by aggregating the acquired information, and manages the processed data as the maintenance information. In the processing of data, for example, aggregation or the like is performed at certain intervals such as daily, weekly, monthly, and yearly. Moreover, as a part of the processing of data, the maintenance information management unit 401 may be configured to perform the calculation of simulations to be displayed on a dashboard screen and manage simulation results as the maintenance information. For example, in the case of detailed simulation, calculation for simulating an influence of a service is performed with respect to information of error content, devices, and products. Therefore, the maintenance information management unit 401 performs simulations for information of error content, devices, and products and manages simulation results as the maintenance information. The maintenance information management unit 401 saves the maintenance information in the storage device 165. The storage device 165 also functions as a maintenance information management DB in which the maintenance information is stored.

The web service provision system 170 includes a user information management unit 411, a maintenance information acquisition unit 412, an administration dashboard provision unit 413, and a management dashboard provision unit 414. The user information management unit 411 manages user information of the device management system 10. For example, the user information management unit 411 performs user authentication when a user logs into the screen provided by the device management system 10. Moreover, the user information management unit 411 manages the authority for each user. Examples of the authority of the user include the authority of an administrator who decides on the introduction of a service provided by the device management system 10, the authority of a manager of a maintenance service, and the authority of an executor who is a serviceman who performs a maintenance service such as repairing a printing device. Moreover, the user information management unit 411 manages simulation settings registered for each user. The simulation settings include, for example, detailed simulation and simplified simulation.

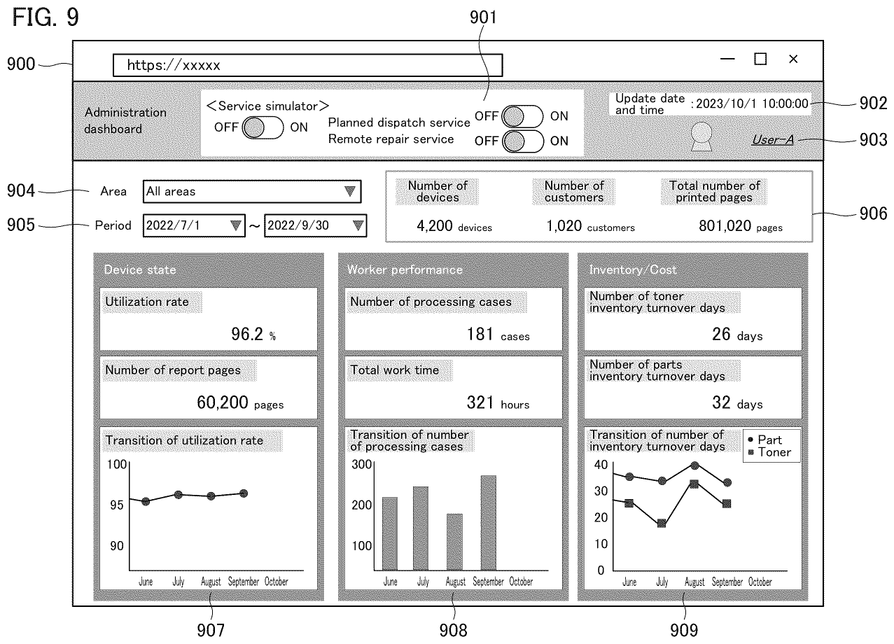

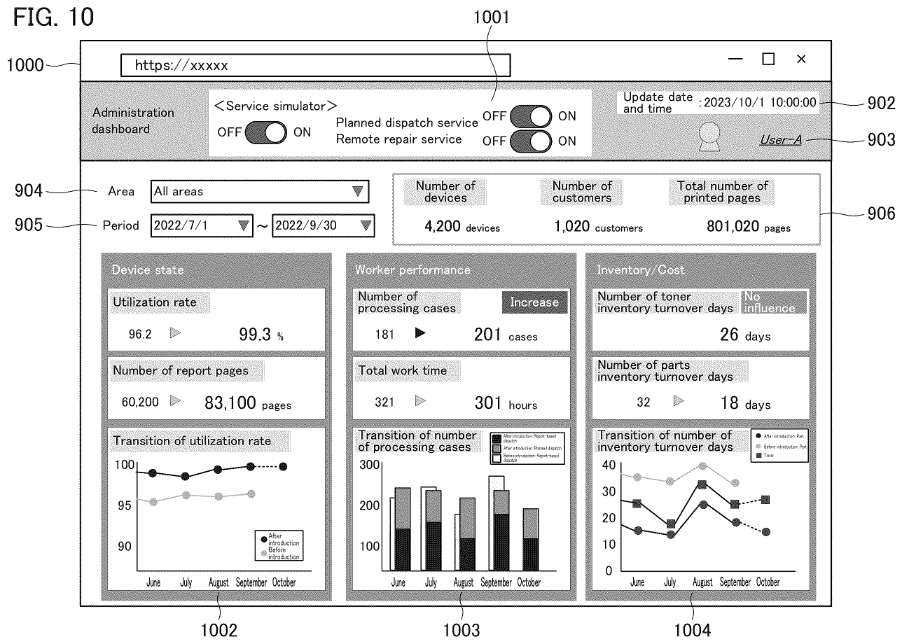

The maintenance information acquisition unit 412 acquires maintenance information from the maintenance information management system 160 . . . . The administration dashboard provision unit 413 generates an administration dashboard screen on the basis of the maintenance information and the like and provides the administration dashboard screen to a user having the authority of the administrator. The administration dashboard screen is a screen on which information about the management and maintenance services for the printing device 100 can be summarized and listed with administration indices, aggregate values, tables, graphs, and the like. The administration dashboard provision unit 413 displays a dashboard screen (FIG. 9) showing data based on maintenance information generated from operation information collected from the printing device 100 and the like and a dashboard screen (FIG. 10) showing simulation results when the service is introduced. Moreover, the administration dashboard provision unit 413 receives changes in setting values in the simulation and provides a simulation screen corresponding to the setting values that have been designated.

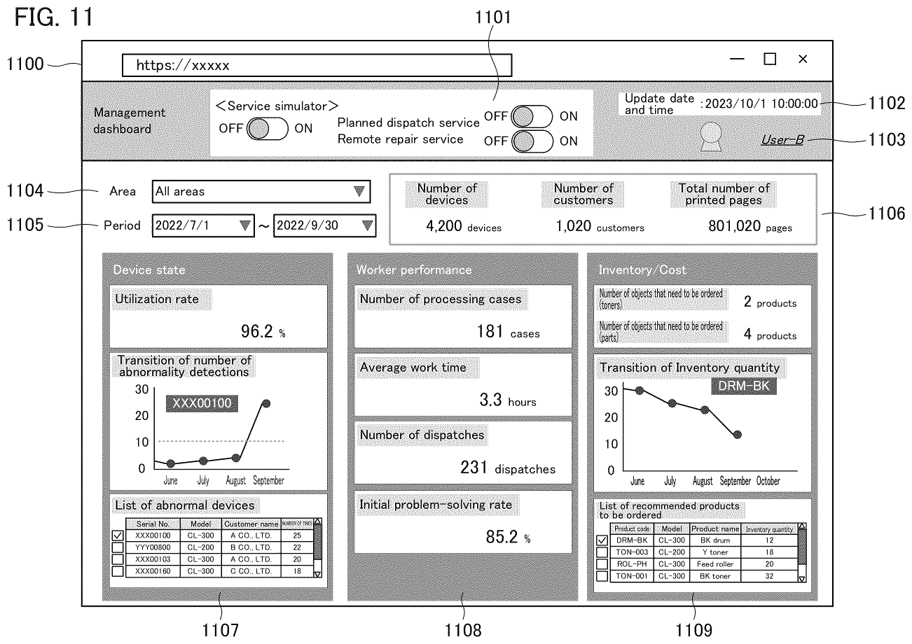

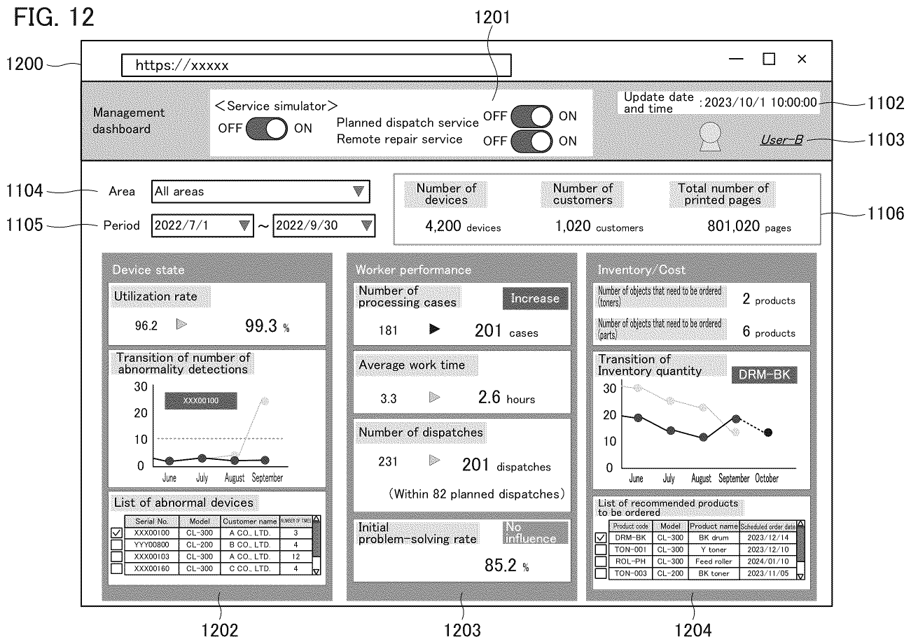

The management dashboard provision unit 414 generates a management dashboard screen based on maintenance information and the like and provides a management dashboard screen to a user having the authority of the manager. The management dashboard screen is a screen on which information about the management and maintenance services for the printing device 100 can be summarized and listed with management indices, aggregate values, tables, graphs, and the like. The management dashboard provision unit 414 displays a dashboard screen (FIG. 11) showing data based on maintenance information generated from operation information collected from the printing device 100 and the like, and a dashboard screen (FIG. 12) showing simulation results when the service is introduced. The administration dashboard provision unit 413 and the management dashboard provision unit 414 provide a dashboard screen to the user by providing the dashboard screen to the host computer 191 via the web browser. Moreover, the management dashboard provision unit 414 receives changes in the setting values in the simulation and provides a simulation screen corresponding to the setting values that have been designated.

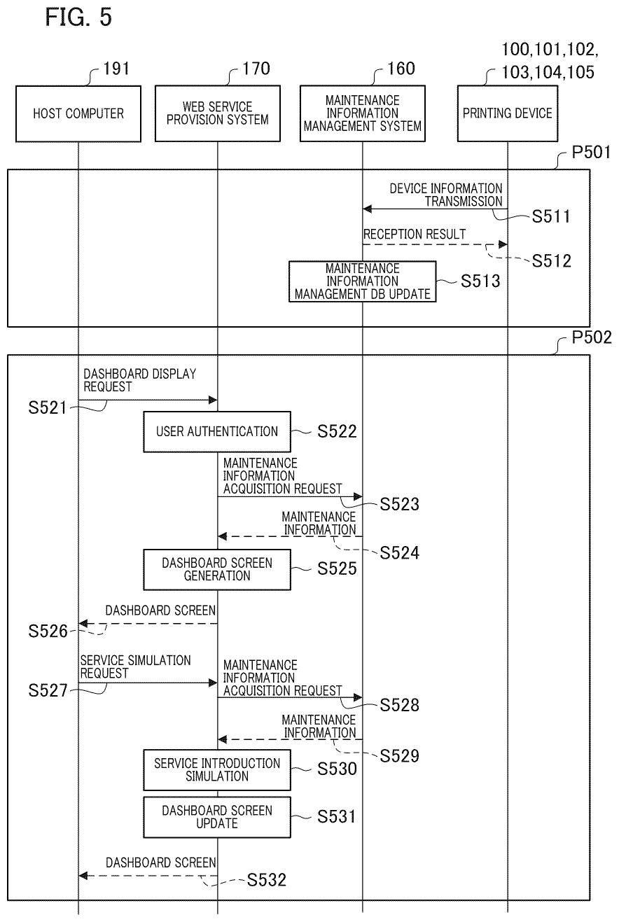

FIG. 5 is a sequence diagram showing a flow of a process of displaying a dashboard screen. When the web service provision system 170 receives a request for displaying the dashboard screen from the host computer 191, the dashboard screen is generated and provided on the basis of maintenance information managed by the maintenance information management system 160. The maintenance information management system 160 manages the maintenance information for use in creating a dashboard on the basis of information collected from the printing device 100.

First, a series of processes denoted by P501 will be described. P501 denotes a maintenance information update process in which the maintenance information management system 160 updates maintenance information on the basis of information received from a management device such as the printing device 100. In S511, the printing device 100 transmits device information to the maintenance information management system 160. The device information includes information for uniquely identifying the device and information indicating an operation state of the device. For example, the device information includes device information such as a serial number of the printing device, counter information for printing and scanning, degrees of wear and tear of parts, usage states of consumables, information about the replacement of parts and consumables, operation information of the device, error information, device setting values, and the like. In S512, the maintenance information management system 160 notifies the printing device 100 of a reception result indicating that the device information has been received normally. In S513, the maintenance information management system 160 updates the maintenance information of the device stored in the storage device 165 on the basis of the received device information.

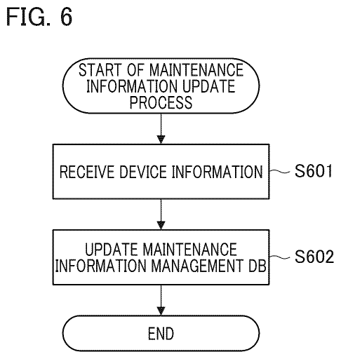

Here, details of the process executed by the maintenance information management system 160 in the maintenance information update process denoted by P501 will be described. FIG. 6 is a flowchart showing the maintenance information update process. The process of FIG. 6 is realized when the CPU 162 of the maintenance information management system 160 reads a program stored in the ROM 163 into the RAM 164 and executes the read program. The process of FIG. 6 is started by transmitting the operation information to the maintenance information management system 160 when the operation information is updated in any one of the printing devices 100 to 105. In addition, the transmission of the operation information by the printing devices 100 to 105 may be in the form of periodic transmission at regular intervals.

In S601, the maintenance information management unit 401 receives device information from any one of the printing devices 100 to 105. The device information includes a serial number of the printing device, device setting values, operation information of the device, and the like. The operation information of the device includes counter information for printing and scanning, degrees of wear and tear of parts, usage states of consumables, information about the replacement of parts and consumables, power-supply information of the device, error information, action information for an error, and the like. Moreover, the maintenance information management unit 401 provides a report of a reception result indicating that the device information has been received normally. In addition to the acquisition of the device information from the device, the maintenance information management unit 401 may be configured to collect an actual result of performing maintenance of the device from the serviceman. Actual result information of the maintenance action includes, for example, work content of maintenance work for the device such as work time and replacement parts.

In S602, the maintenance information management unit 401 updates the maintenance information management DB stored in the storage device 165 on the basis of the device information received in S601 and actual maintenance result information collected from the serviceman or the like, and ends the present process. The maintenance information management unit 401 updates the maintenance information by updating the maintenance information management DB stored in the storage device 165. In the maintenance information management DB update process, a process of overwriting the maintenance information management DB with the latest information received in S601, a process of adding the latest information received in S601 to the maintenance information management DB and storing an addition result, and the like are performed. Furthermore, a process of processing data is performed on the basis of data updated to the latest information received in S601. In the processing of data, for example, aggregation or the like is performed at certain intervals such as daily, weekly, monthly, and yearly.

Next, a series of processes denoted by P502 will be described. P502 denotes a process in which the web service provision system 170 generates a dashboard screen on the basis of maintenance information and provides the generated dashboard screen to the host computer 191. In S521, the host computer 191 transmits a dashboard display request to the web service provision system 170. In S522, the web service provision system 170 performs user authentication for the user who has transmitted the dashboard display request. In the user authentication, the web service provision system 170 also confirms the authority owned by the user.

In S523, the web service provision system 170 transmits a maintenance information acquisition request to the maintenance information management system 160. In S524, the maintenance information management system 160 returns the maintenance information stored in the storage device 165 as a response to the maintenance information acquisition request to the web service provision system 170. In S525, the web service provision system 170 generates a dashboard screen on the basis of the maintenance information that has been acquired. In S526, the web service provision system 170 provides the dashboard screen generated in S525 to the host computer 191 via the web browser.

In S526, the host computer 191 transmits a simulation request to the web service provision system 170. In S528, the web service provision system 170 transmits a maintenance information acquisition request to the maintenance information management system 160. In S529, the maintenance information management system 160 returns maintenance information stored in the storage device 165 as a response to the maintenance information acquisition request to the web service provision system 170. In S530, the web service provision system 170 simulates an introduction of a service for device management on the basis of the maintenance information that has been acquired. In S531, the web service provision system 170 generates a dashboard screen showing service introduction simulation results. In S532, the web service provision system 170 provides the dashboard screen generated in S531 to the host computer 191 via the web browser.

Here, dispatch information, inventory information, and device management information related to the maintenance service for the printing device transmitted via a host computer, a mobile terminal, or the like are similarly collected in the maintenance information management system 160 (although not shown in the drawing). The dispatch information includes a dispatch date, a worker, work time, a serial number of a printing device that is a dispatch target, a reason for dispatch, action content, and the like. The inventory information includes the number of toners or parts in inventory, a date of inventory confirmation, the number of orders, a date of ordering, an orderer, the number of uses, a date of use, a user, a serial number of a used printing device, and the like. The device management information includes a serial number of a printing device, model information, an installation location, information of a customer who owns the printing device, maintenance contract information, user information, and the like.

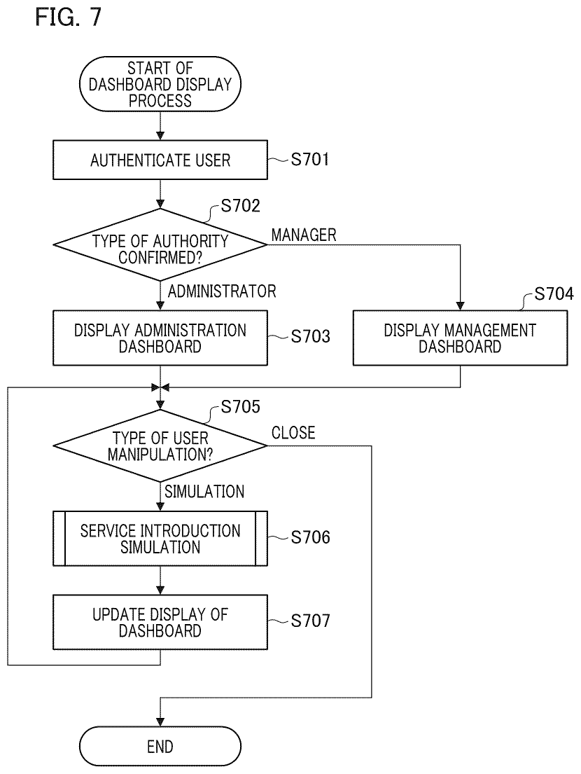

The process executed by the web service provision system 170 in the dashboard display process of P502 will be described with reference to FIG. 7. FIG. 7 is a flowchart showing the dashboard display process. The process shown in FIG. 7 is realized when the CPU 172 of the web service provision system 170 reads a program stored in the ROM 173 or the like into the RAM 174 and executes the read program. The process of FIG. 7 starts when the user designates a uniform resource locator (URL) of the dashboard display screen on the web browser operating in the host computer 191.

In S701, the user information management unit 411 receives an input of user authentication information from the user via the host computer 191 and performs a user authentication process. When user authentication has succeeded, the processing of $402 is performed. On the other hand, when the user authentication has failed, the present process ends. In the present embodiment, description will be given under the assumption that the user authentication has succeeded.

In S702, the user information management unit 411 confirms the user's authority information for displaying the dashboard. In the present embodiment, the user information management unit 411 confirms whether the user has the authority of the administrator or the authority of the manager. Because the dashboard to be provided differs according to the authority of the user, the authority of the user is confirmed. In the case of the authority of the administrator, the processing of S703 is performed. On the other hand, in the case of the authority of the manager, the processing of S704 is performed. If the user does not have either the authority of the administrator or the authority of the manager, the present process ends because the user does not have the authority to display the dashboard.

Although an example of the authority of the administrator and the authority of the manager as the authority of the user to confirm the dashboard has been described in S702 in the present embodiment, the authority may be another authority to display the dashboard. Moreover, in addition to the authority associated with the user, the presence or absence of the authority may be confirmed on the basis of a device desired to display the dashboard. For example, on-site personnel may have the same authority as the manager for a dashboard display process, but there are restrictions on devices from which the dashboard can be confirmed and the on-site personnel may confirm the dashboard only when he or she has performed a login process from some devices.

In S703, the administration dashboard provision unit 413 generates an administration dashboard screen on the basis of the maintenance information acquired from the maintenance information management system 160 and provides the generated administration dashboard screen to the host computer 191. Specifically, the maintenance information acquisition unit 412 transmits a maintenance information acquisition request to the maintenance information management system 160 and acquires maintenance information as a response to the request from the maintenance information management system 160. The administration dashboard provision unit 413 generates the administration dashboard screen on the basis of the acquired maintenance information. Also, the administration dashboard provision unit 413 provides the generated management dashboard screen as a web page to the web browser of the host computer 191. The CPU 192 of the host computer 191 displays the administration dashboard screen provided from the web service provision system 170 via the web browser on the display unit 197.

Here, a screen for business administration provided by the web service provision system 170 will be described. FIG. 9 is a diagram showing an example of a business administration screen by a dashboard style. The administration dashboard screen 900 is a screen showing actual result data related to device maintenance and shows data based on maintenance information generated from operation information collected from a device, an actual result report from a serviceman, and the like. The administration dashboard screen 900 includes a service simulator switch 901, a screen update date and time 902, a user name 903, a designated area 904, a display target period 905, and basic maintenance service information 906. Moreover, the administration dashboard screen 900 includes device state information 907, worker performance information 908, and inventory information 909 as administration indices for a maintenance service administrator to make administration determination. Although an example in which a device state, worker performance, and inventory are displayed as the administration indices will be described in the present embodiment, the administration indices are not limited thereto, and for example, revenue, cost, work quality, and the like may be displayed as the administration indices.

The service simulator switch 901 is a switch that performs a switching process between validity and invalidity of the simulation of administration indices for the maintenance service administrator to make administration determination when the service has been introduced. That is, the service simulator switch 901 can switch between whether or not to display the simulation of the device state information 907, the worker performance information 908, and the inventory information 909 when the service has been introduced. Moreover, it is possible to perform a switching process between validity and invalidity of simulation for each service. In the example shown in FIG. 9, the service simulator switch 901 can perform a switching process between validity and invalidity of simulation for each service with respect to two services, i.e., a planned dispatch service and a remote repair service. The planned dispatch service and the remote repair service are services provided by the maintenance information management system 160. The planned dispatch service is a service for enabling planned dispatch and inventory arrangement by analyzing when dispatch is required on the basis of device information acquired from a management target device such as the printing device 100. The remote repair service is a service for analyzing error information and device operation information included in the device information acquired from a management target device such as the printing device 100 and eliminating an error occurring in the device according to a manipulation from a remote location. In the example shown in FIG. 9, both the simulation display of the planned dispatch service and the remote repair service are invalidated (OFF).

In the screen update date and time 902, a date and time when the administration dashboard screen 900 is generated is displayed. The screen update date and time 902 indicates that the dashboard displays maintenance information at this date and time. In the user name 903, user information authenticated in S701 is displayed. In the designated area 904, an area designated as a display target is displayed. In the designated area 904, the user can select and designate an area. In the display target period 905, a period of display on the dashboard is displayed. In the display target period 905, the user can designate a start date and an end date of the display target period. The designated area 904 and the display target period 905 are, for example, pull-down, and the information to be displayed on the dashboard can be narrowed down when the user performs manipulation and designation operations. Although an example in which an area and a period are designated as a condition for narrowing down the display target has been described in the present embodiment, the present disclosure is not limited thereto.

Basic information about the maintenance service is displayed in the basic maintenance service information 906. For example, in the basic maintenance service information 906, the number of devices, which are maintenance service targets, the total number of printed pages from the device, and the number of customers making a contract for the maintenance service are displayed as basic information about the maintenance service. In the device state information 907, aggregate data indicating an operation state of a maintenance service target device is displayed. For example, in the device state information 907, a numerical value of a utilization rate of the device, a monthly transition graph of the utilization rate, and a numerical value of the average number of report pages that is the number of printed pages output during reports from customers in devices are displayed. Although a display process is performed so that a period before or after the display target period is included when a monthly transition graph is displayed in the present embodiment, the display target period may be displayed in a close-up or expanded to annual display. In the worker performance information 908, aggregate data indicating the performance state of the worker is displayed. For example, in the worker performance information 908, a numerical value of the average number of processing cases per worker, a monthly transition graph of the number of processing cases, and a numerical value of the total work time are displayed. In the inventory information 909, aggregate data indicating the inventory management state is displayed. For example, in the inventory information 909, a numerical value of the average number of inventory turnover days from the time a toner is ordered to the time the toner is used, a numerical value of the average number of inventory turnover days from the time a part is ordered to the time the part is used, and a monthly transition graph of the number of inventory turnover days for each toner or part is displayed.

Referring back to FIG. 7, in S704, the management dashboard provision unit 414 generates a management dashboard screen on the basis of the maintenance information acquired from the maintenance information management system 160 and provides the generated management dashboard screen to the host computer 191. Specifically, the maintenance information acquisition unit 412 transmits a maintenance information acquisition request to the maintenance information management system 160 and acquires maintenance information as a response to the request from the maintenance information management system 160. The management dashboard provision unit 414 generates a management dashboard screen on the basis of the acquired maintenance information. Also, the management dashboard provision unit 414 provides the generated management dashboard screen as a web page to the web browser of the host computer 191. The CPU 192 of the host computer 191 displays the management dashboard screen provided from the web service provision system 170 via the web browser on the display unit 197.

Here, a screen for a device management provided by the web service provision system 170 will be described. FIG. 11 is a diagram showing an example of a management screen by the dashboard style. A management dashboard screen 1100 includes a service simulator switch 1101, a screen update date and time 1102, a user name 1103, a designated area 1104, a display target period 1105, and basic maintenance service information 1106. Moreover, the management dashboard screen 1100 includes device state information 1107, worker performance information 1108, and inventory information 1109 as management indices for the maintenance service manager to act.

The service simulator switch 1101 is a switch that switches between whether or not to display simulation of a management index for the maintenance service administrator to act when the service has been introduced. That is, the service simulator switch 1101 can switch between whether or not to display the simulation of the device state information 1107, the worker performance information 1108, and the inventory information 1109. Moreover, it is possible to perform a switching process between validity and invalidity of simulation for each service. In the example shown in FIG. 11, the service simulator switch 1101 can switch the display of the simulation when two services, i.e., a planned dispatch service or a remote repair service, have been introduced. In the example shown in FIG. 11, both the display of the simulation of the planned dispatch service and the display of the simulation of the remote repair service are turned off.

In the screen update date and time 1102, a date and time when the management dashboard screen 1100 is generated is displayed. The screen update date and time 1102 indicates that the dashboard displays maintenance information at this date and time. In the user name 1103, user information authenticated in S701 is displayed. In the designated area 1104, an area designated as a display target is displayed. In the designated area 1104, the user can select and designate an area. In the display target period 1105, a period of display on the dashboard is displayed. In the display target period 1105, the user can designate a start date and an end date of the display target period. The designated area 1104 and the display target period 1105 are, for example, pull-down, and the information to be displayed on the dashboard can be narrowed down when the user performs manipulation and designation operations. Although an example in which an area and a period are designated as a condition for narrowing down the display target has been described in the present embodiment, the present disclosure is not limited thereto.

Basic information about the maintenance service is displayed in the basic maintenance service information 1106. For example, in the basic maintenance service information 1106, the number of devices, which are maintenance service targets, the total number of printed pages from the device, and the number of customers making a contract for the maintenance service are displayed as basic information about the maintenance service. In the device state information 1107, aggregate data indicating an operation state of a maintenance service target device is displayed. For example, in the device state information 1107, a numerical value of a utilization rate of a device, a table of an abnormal device list in which the number of abnormality detections in the device exceeds a certain threshold value, and a monthly transition graph of the number of abnormality detections in the device designated in the abnormal device list are displayed. In the worker performance information 1108, aggregate data indicating a performance state of the worker is displayed. For example, in the worker performance information 1108, a numerical value of the average number of processing cases per worker, a numerical value of the average number of dispatches per worker, a numerical value of the average work time per case, and a numerical value that is an average value of an initial problem-solving rate at which the problem could be solved by the first dispatch are displayed. In the inventory information 1109, aggregate data indicating the inventory management state is displayed. For example, in the inventory information 1109, a numerical value of the number of products such as toners and parts that need to be ordered when the inventory falls below a certain threshold value, a table of a product list recommended for ordering, and a monthly transition graph of the number of products in inventory designated in the product list recommended for ordering are displayed.

Referring back to FIG. 7, in S705, the administration dashboard provision unit 413 or the management dashboard provision unit 414 receives a manipulation from the user on the displayed dashboard via the manipulation unit 195 of the host computer 191. When the received manipulation is a manipulation of switching ON/OFF of the service simulator switch 901 or the service simulator switch 1101, the processing of S706 is performed. On the other hand, when a manipulation of closing the web browser in which the dashboard is displayed is performed, the present process ends.

In S706 and S707, the administration dashboard provision unit 413 or the management dashboard provision unit 414 updates the display of the dashboard in accordance with a manipulation on the service simulator switch 901 or the service simulator switch 1101. In the present embodiment, an example in which the simulations of both the planned dispatch service and the remote repair service are validated according to a manipulation on the service simulator switch 901 or the service simulator switch 1101 will be described.

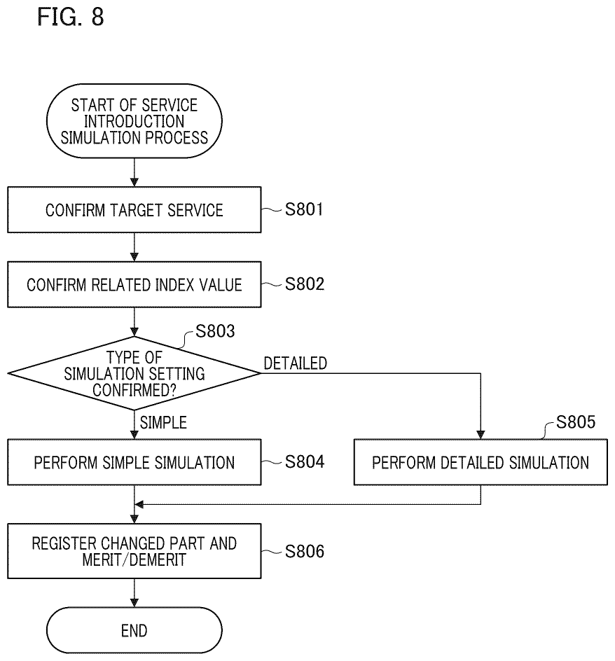

In S706, the administration dashboard provision unit 413 or the management dashboard provision unit 414 performs simulation when a service validated according to a manipulation of the user has been introduced. Here, details of a service introduction simulation process executed by the web service provision system 170 will be described with reference to FIG. 8. FIG. 8 is a flowchart showing the service introduction simulation process in Embodiment 1. The process of FIG. 8 is realized when the CPU 172 of the web service provision system 170 reads a program stored in the ROM 173 or the like into the RAM 174 and executes the program. Here, a case where the service simulator switch 901 is turned on in the administration dashboard screen 900 and the administration dashboard provision unit 413 executes the service introduction simulation process will be described as an example. A similar process is performed even if the management dashboard provision unit 414 executes the service introduction simulation process.

In S801, the administration dashboard provision unit 413 confirms the service validated in S705. Here, it is confirmed whether the simulation of the planned dispatch service or the remote repair service provided by the maintenance information management system 160 has been validated. The planned dispatch service is a service that enables planned dispatch and inventory arrangement by analyzing when dispatch is required on the basis of the device information acquired from the device in S601 or the like. For example, in the planned dispatch service, by detecting the risk of a defect due to the part on the basis of information of the degree of wear and tear of the part, it is possible to provide a report of the remaining number of days until the defect occurs and enable planned dispatch of a maintenance serviceman and inventory arrangement. The remote repair service is a service for analyzing error information and device operation information included in device information acquired from a device in S601 or the like and eliminating an error occurring in the device according to a manipulation from a remote location. In addition, these services are examples and may be related to maintenance services of other devices.

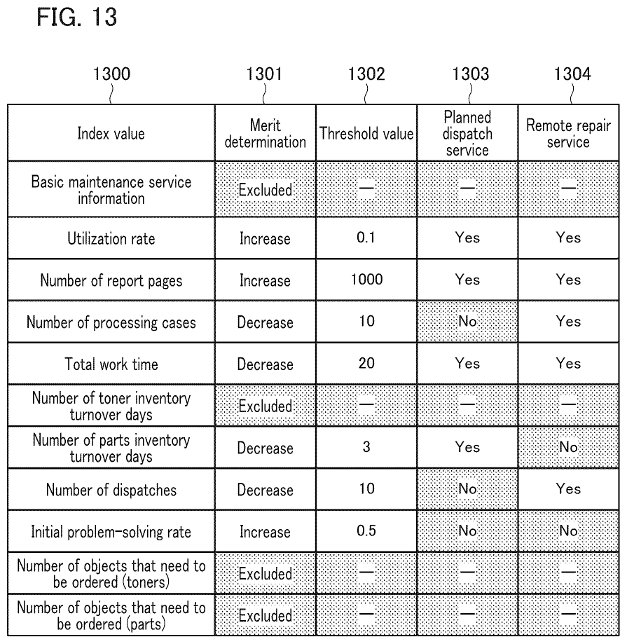

In S802, the administration dashboard provision unit 413 confirms the handling of index values related to the simulation of each service and confirms the index values that change according to the simulation. FIG. 13 is a diagram showing an example of a list for describing the handling of index values. The list includes information about index values 1300, merit determination 1301, a threshold value 1302, planned-dispatch-service-related information 1303, and a remote repair service 1304. The index values 1300 include, for example, basic maintenance service information, a utilization rate, the number of report pages, the number of processing cases, the total work time, the number of toner inventory turnover days, the number of parts inventory turnover days, the number of dispatches, an initial problem-solving rate, the number of toners that need to be ordered, and the number of parts that need to be ordered. The merit determination 1301 indicates whether there is a merit in either a case where the numerical value increases or a case where the numerical value decreases for each index value. The merit indicates that there is the effect of introduction of the service that has been simulated. Moreover, when the numerical change is opposite to the increment/decrement of the merit determination 1301, it is determined that there is a demerit. The threshold value 1302 is a threshold value of a change in the numerical value that is said to have a merit or demerit. The case of a change of less than a numerical value set in the threshold value 1302 is not treated as a merit or demerit because there is no change.

The planned-dispatch-service-related information 1303 indicates whether or not there is a change in the index value due to the simulation of the planned dispatch service. The utilization rate, the number of report pages, the total work time, and the number of parts inventory turnover days for which the planned-dispatch-service-related information 1303 is Yes are index values that change in the simulation of the planned dispatch service. The remote repair service 1304 indicates whether or not there is a change in the index value due to the simulation of the remote repair service. The utilization rate, the number of report pages, the number of processing cases, the total work time, and the number of dispatches for which the information of the remote repair service 1304 is Yes are index values that change in the simulation of the remote repair service.

In S803, the administration dashboard provision unit 413 confirms simulation settings. Specifically, the administration dashboard provision unit 413 confirms whether detailed simulation is set or whether simple simulation is set. The simple simulation is simulation in which only representative index values are simulated, an amount of calculation and an amount of information to be confirmed are reduced compared with the detailed simulation, and a simulation result is displayed as soon as possible. The administration dashboard provision unit 413 confirms simulation settings on the basis of simulation settings registered in advance in the storage device 196 as user-specific settings or simulation settings designated from the user via the manipulation unit 195. When the simple simulation is set, the processing of S804 is performed. On the other hand, when the detailed simulation is set, the processing of S805 is performed.

A case where the simple simulation is performed will be described. In S804, the administration dashboard provision unit 413 performs the simple simulation for an index value that changes according to the simulation confirmed in S802. In the simple simulation, the simulation results are displayed as soon as possible by reducing an amount of calculation and an amount of information to be confirmed. For example, a process can be performed at a high speed by applying a certain parameter only to a current utilization rate and a utilization rate aggregated for each month or by applying a certain parameter without confirming individual error content of the number of processing cases. Alternatively, the content of the previous simulation may be held and the simulation calculation may be performed only on added data. In a case where a large amount of calculation is required as in simulation for each device or each product, it may be excluded from a simulation target in the case of the simple simulation.

A case where the detailed simulation is performed will be described. In S805, the administration dashboard provision unit 413 performs detailed simulation for an index value that changes according to the simulation confirmed in S802. In the detailed simulation, calculation for simulating an influence of a service is performed for each information item such as each error content item, each device, or each product. Here, an increase in an amount of calculation or an amount of information to be handled in the web service provision system 170 in S805 may be suppressed by registering a result of simulation performed by the maintenance information management system 160 during the maintenance information update process in S602 in the maintenance information management DB.

In S806, the administration dashboard provision unit 413 determines a changed part and a merit/demerit with respect to the index value on which simulation calculation has been performed in S804 or S805, registers the determined changed part and merit/demerit to be displayed on the management dashboard screen, and ends the present process. The administration dashboard provision unit 413 determines the changed part according to whether there is a change exceeding the threshold value 1302. Moreover, the administration dashboard provision unit 413 determines whether the change is a merit or a demerit for the changed part exceeding the threshold value 1302. The administration dashboard provision unit 413 determines that the change exceeding the threshold value is a merit when it matches the merit determination 1301 and determines that the change exceeding the threshold value is a demerit when it does not match the merit determination 1301.

Referring back to FIG. 7, in S707, the administration dashboard provision unit 413 updates the administration dashboard screen or the management dashboard screen on the basis of a simulation result of S706 and provides the updated dashboard screen to the host computer 191. The CPU 192 of the host computer 191 displays the updated dashboard screen on the display unit 197. In addition to a simulation result of S804 or S805, the dashboard screen also displays the merit and demerit of S806. Any merit/demerit display format may be used as long as the user can recognize the merit/demerit, the merit/demerit may be displayed by words or icons, or may be displayed by color. When the updated screen is provided to the host computer 191, the web service provision system 170 returns to the processing of S705. In addition, in S707, when the dashboard screen includes a plurality of user interface (UI) parts, only the UI parts that need to be updated are updated, and the UI parts that do not need to be updated are not updated, such that a period of time required for display is shortened.

Here, an example of an updated dashboard in which a simulation result is reflected will be described. FIG. 10 is a diagram showing an example of an administration dashboard screen in which a simulation result is reflected. An administration dashboard screen 1000 is a screen showing a result of simulating the effect of introduction of a service for managing a device. In the present embodiment, on the administration dashboard screen 1000, the simulation results are displayed comparably with the actual result data related to the maintenance of the device. The administration dashboard screen 1000 is an administration dashboard screen in which a detailed simulation result is reflected. In a service simulator switch 1001 of the administration dashboard screen 1000, both the simulation of the planned dispatch service and the simulation of the remote repair service are validated.

In the administration dashboard screen 1000 in which a simulation result is reflected, the simulation result after the introduction of the service is displayed in a value of an administration index for a maintenance service administrator to make administration determination. Specifically, the administration index obtained by adding a simulation result to the device state information 907 is displayed in device state information 1002. In worker performance information 1003, the administration index obtained by adding the simulation result to the worker performance information 908 is displayed. In inventory information 1004, the administration index obtained by adding the simulation result to the inventory information 909 is displayed. According to the inventory information 1004, it is possible to estimate the required number of parts or consumables, so that an increase in a quantity of inventory to be held can be suppressed. In the example shown in FIG. 10, the administrator can imagine that the introduction of the service is effective as a whole while understanding the demerit that the number of processing cases increases due to the advance action through planned dispatch or the early action through remote repair.

FIG. 12 is a diagram showing an example of an administration dashboard screen in which a simulation result is reflected. A management dashboard screen 1200 is a management dashboard screen in which a detailed simulation result is reflected. In a service simulator switch 1201 of the management dashboard screen 1200, both the simulation of the planned dispatch service and the simulation of the remote repair service are validated.

In the management dashboard screen 1200 in which a simulation result is reflected, the simulation result after the service introduction is displayed in the value of the management index for the maintenance service manager to act. Specifically, a management index obtained by adding the simulation result to the device state information 1107 is displayed in device state information 1202. In worker performance information 1203, a management index obtained by adding the simulation result to the worker performance information 1108 is displayed. In inventory information 1204, a management index obtained by adding the simulation result to the inventory information 1109 is displayed. According to the device state information 1202, it is possible to suppress an increase in the number of abnormality detections in the corresponding device by taking the advance action at a point in time in August when there is a sign of the occurrence of the phenomenon. In the example shown in FIG. 11, the manager can imagine that the introduction of the service is effective as a whole while understanding the demerit that the number of processing cases increases due to the advance action through planned dispatch or the early action through remote repair.

In addition, because it is possible to predict the possibility of the work plan for the next month in the simulation of the planned dispatch service, a predicted result for the next month may be displayed in some transition graphs. For example, the results of the following month are also displayed in a transition graph of the number of processing cases in the worker performance information 1003 of the administration dashboard screen 1000, a transition graph of the number of inventory turnover days in the inventory information 1004, and a transition graph of an inventory quantity in the inventory information 1204 of the management dashboard screen 1200.

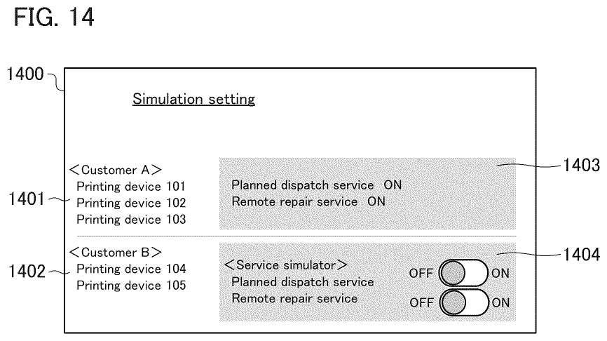

Although description has been given using a case where the service is not introduced to all devices before the simulation in the present embodiment, a case where the service is introduced to some devices may be used. FIG. 14 is a diagram showing an example of a simulation setting screen when devices to which a service has been introduced and devices to which a service has not been introduced are mixed. A simulation setting screen 1400 is displayed on the dashboard instead of the service simulator switch 901 or the service simulator switch 1101. On the simulation setting screen 1400, introduced service information 1403 corresponding to a device group 1401 owned by customer A and a service simulator switch 1404 corresponding to a device group 1402 owned by customer B are displayed. By turning on the service simulator switch 1404, the service introduction simulation process is performed for the device group 1402 owned by customer B. Thereby, it is possible to provide a dashboard for comparing a current state with the effect of introduction of a service.

In the present embodiment, a case where the effect of the introduction of the service can be confirmed by turning on the service simulator switch for a device group to which the service has not been introduced has been described. In contrast, it is also possible to display the simulation of a case where a service that has already been introduced is invalidated. For a device group to which the service has already been introduced, it is possible to cause an improvement effect of the introduced service to be reaffirmed by performing service invalidation simulation when the service simulator switch is turned off and displaying a simulation result on the dashboard.

As described above, according to the present embodiment, it is possible to display a result of simulating the effect of introduction of a network device management service that has been newly introduced on the dashboard to provide the simulation result while presenting various indices related to maintenance service business. By simulating the effect of introduction of a new service for each index, it is possible to confirm how effective the service is for each role, which can lead to a smooth introduction of the service.

### Embodiment 2

In Embodiment 1, an example in which simulation can be performed with two simulation settings of the detailed simulation and the simple simulation has been described. In the present embodiment, an example in which setting value change simulation for executing simulation by changing a setting value of a new service to be simulated in accordance with the user's designation can be executed as the detailed simulation will be described. Hereinafter, only differences from Embodiment 1 will be described. Also, processing steps and components identical to those in Embodiment 1 are denoted by the same reference signs and description thereof will be omitted. Although an example in which an administration dashboard screen is provided will be described in the present embodiment, a case where a management dashboard screen is provided is also similar.

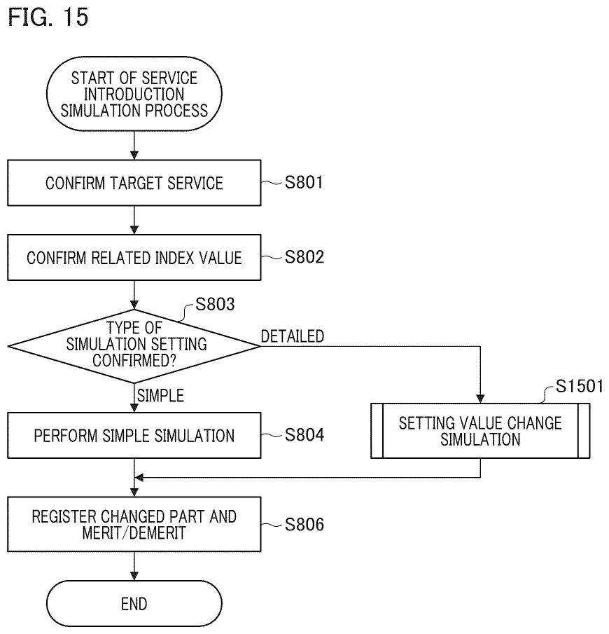

FIG. 15 is a flowchart showing a service introduction simulation process in Embodiment 2. The process of FIG. 15 is realized when the CPU 172 of the web service provision system 170 reads a program stored in the ROM 173 or the like into the RAM 174 and executes the program. When it is determined that the simulation setting is detailed simulation in S803, the processing of S1501 is performed.

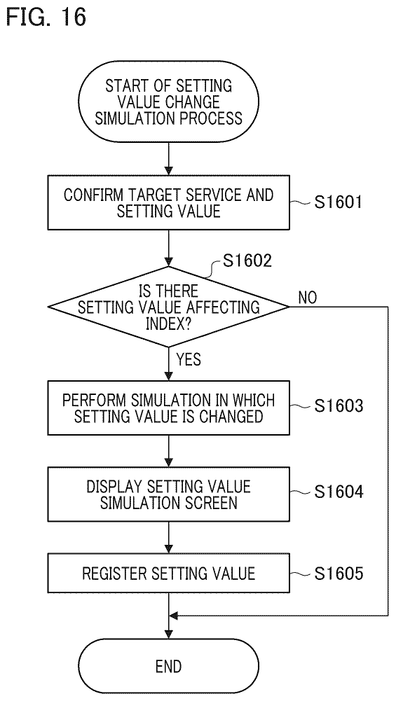

In S1501, the administration dashboard provision unit 413 performs the setting value change simulation as the detailed simulation for an index value that changes due to the simulation confirmed in S802. In the setting value change simulation, the setting value of the new service to be simulated is changed in accordance with the user's designation and the simulation is performed. Here, the process of the setting value change simulation will be described with reference to FIG. 16. FIG. 16 is a flowchart showing the setting value change simulation process. The process of FIG. 16 is realized when the CPU 172 of the web service provision system 170 reads a program stored in the ROM 173 or the like into the RAM 174 and executes the program.

In S1601, the administration dashboard provision unit 413 confirms the information of the setting value of the service validated in S705. Here, it is assumed that a LIFE value indicating a timing of replacement of a part in the planned dispatch service can change. As the LIFE value increases, the part is indicated to be used for a long time and the number of reports due to the occurrence of an error and the like increases. Therefore, if the part is replaced when the LIFE value is small, the report rate is low. On the other hand, if the part is replaced while the LIFE value is small, the replacement frequency of the part increases and the cost of the part increases. In S1602, the administration dashboard provision unit 413 confirms whether there is an index value to be affected by a change in the setting value confirmed in S1601. When there is an index value to be affected, the processing of S1603 is performed. On the other hand, when there is no index value to be affected, the present process ends. Here, it is assumed that the setting of the LIFE value affects the report rate and the cost of parts.

In S1603, the administration dashboard provision unit 413 performs simulation in which the setting value is changed. Here, it is assumed that simulation in which a four-level setting value as the LIFE value to be set to 100, 120, 140, and 160 is changed has been executed. In S1604, the administration dashboard provision unit 413 generates a setting value simulation screen and provides the setting value simulation screen to the host computer 191. The CPU 192 of the host computer 191 displays the setting value simulation screen on the display unit 197. Moreover, the administration dashboard provision unit 413 receives a change in the setting value on the setting value simulation screen via the host computer 191.

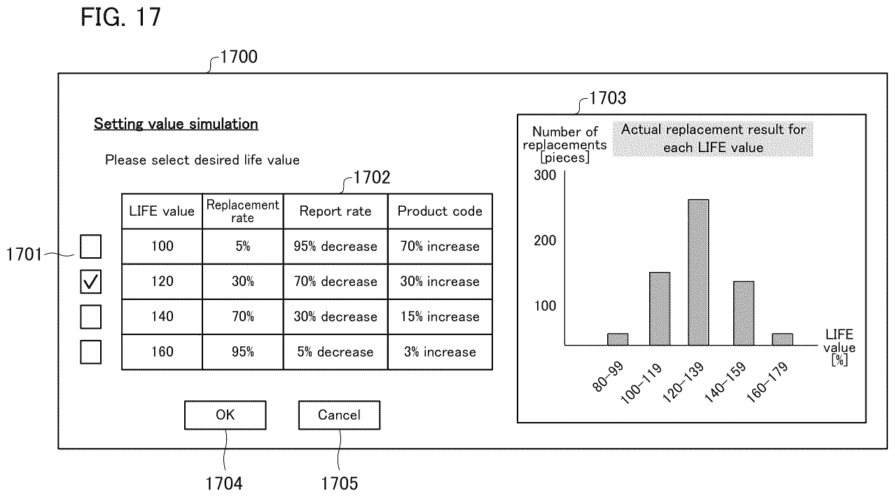

FIG. 17 is a diagram showing an example of the setting value simulation screen in Embodiment 2. The setting value simulation screen 1700 is a setting value simulation screen in the introduction simulation of the planned dispatch service. The setting value simulation screen 1700 includes a setting value selection check box 1701, a setting value simulation result 1702, simulation-related data 1703, an OK button 1704, and a Cancel button 1705. In the setting value simulation result 1702, the merit of an effect of the decrease in the parts replacement rate in each LIFE value and the report rate due to the introduction of the planned dispatch service and the demerit of the increase in the parts cost due to the increase in the parts replacement are displayed. In the simulation-related data 1703, a graph of an actual replacement result for each LIFE value is displayed. The user confirms the merit or demerit of the introduction of the service by confirming the setting value simulation result 1702 and the simulation-related data 1703, and then selects a desired setting value (LIFE value) with the setting value selection check box 1701. When the OK button 1704 is pressed after the setting value is selected in the setting value selection check box 1701, the setting value is decided. In addition, when the Cancel button 1705 is selected, the present process ends and simulation is performed at the initial value without changing the setting value.

In S1605, the administration dashboard provision unit 413 registers the setting value received in S1604 and the simulation result with the setting value to be displayed on the management dashboard screen, and ends the present process. Although setting value simulation is performed in the case where all parts to be replaced are replaced with a uniform LIFE value in the present embodiment, the setting value differing according to each part may be used. When the setting value differing according to each part may be used, because the amount of calculation increases as the target setting value increases, the setting value simulation process may be calculated in advance with the maintenance information management system 160 or the like.

As described above, according to the present embodiment, the user can set the setting value for use in the simulation. Moreover, by changing the setting value, it is possible to simulate the effect of introduction of a new service in more detail and it is possible to confirm how effective the introduction of the service is under various assumptions, which can lead to a smooth introduction of the service.

### OTHER EMBODIMENTS

Embodiment(s) of the present disclosure can also be realized by a computer of a system or device that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or device by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., a CPU and a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-107292, filed Jun. 29 2023, which is hereby incorporated by reference wherein in its entirety.

What is claimed is:

1. A device management system for managing a network device, the device management system comprising:
a memory storing instructions; and
a processor executing the instructions causing the device management system to:
provide data generated on the basis of maintenance information including operation information collected from the network device serving as a service target; and
provide a simulation result of simulating effect of introduction of a service for managing the network device,
wherein, when a setting value of the service for use in simulation is designated, the simulation result based on the setting value is provided.

2. The device management system according to claim 1, wherein the effect of the introduction of the service is provided, along with data indicating a demerit of the introduction of the service, in a dashboard style as the simulation result.

3. The device management system according to claim 2, wherein data for which the effect of the introduction of the service is obtained and data subjected to a demerit due to the introduction of the service are displayed in different colors.

4. The device management system according to claim 2, wherein presence or absence of the effect of the introduction and a demerit is determined on the basis of an increment or decrement in each index value of the result of simulating the effect of the introduction of the service for each index value of the data generated on the basis of the maintenance information.

5. The device management system according to claim 1, wherein switching between validity and invalidity of the simulation of the introduction of the service is possible.

6. The device management system according to claim 5, wherein the device management system supports a plurality of services, and
wherein the switching between the validity and invalidity of the simulation of the introduction of the service can be performed for each service.

7. The device management system according to claim 1, wherein the instructions further cause the device management system to provide a screen of simulation of a setting value indicating an index of each setting value of the service for use in the simulation and receives a change in the setting value of the screen of the simulation of the setting value.

8. The device management system according to claim 1,
wherein the network device is an image forming device, and
wherein the service is a service related to maintenance of the network device.

9. The device management system according to claim 8,
wherein the maintenance information includes error information of the network device, a usage state of a consumable in the network device, the number of printed pages in the network device, and actual result information of maintenance action for the network device, and
wherein a simulation target includes at least one item of information about a utilization rate of the network device, a maintenance work count or time of a serviceman for the network device, and information related to inventory of consumables of the network device.

10. A control method of a device management system for managing a network device, the control method comprising:
providing data generated on the basis of maintenance information including operation information collected from the network device serving as a service target; and
providing a simulation result of simulating effect of introduction of a service for managing the network device,
wherein, when a setting value of the service for use in simulation is designated, the simulation result based on the setting value is provided.

11. The control method according to claim 10, wherein the effect of the introduction of the service is provided, along with data indicating a demerit of the introduction of the service, in a dashboard style as the simulation result.

12. The control method according to claim 11, wherein data for which the effect of the introduction of the service is obtained and data subjected to a demerit due to the introduction of the service are displayed in different colors.

13. The control method according to claim 11, wherein presence or absence of the effect of the introduction and a demerit is determined on the basis of an increment or decrement in each index value of the result of simulating the effect of the introduction of the service for each index value of the data generated on the basis of the maintenance information.

14. The control method according to claim 10, wherein switching between validity and invalidity of the simulation of the introduction of the service is possible.

15. The control method according to claim 14, wherein the device management system supports a plurality of services, and
wherein the switching between the validity and invalidity of the simulation of the introduction of the service can be performed for each service.

16. The control method according to claim 10, further providing a screen of simulation of a setting value indicating an index of each setting value of the service for use in the simulation and receives a change in the setting value of the screen of the simulation of the setting value.

17. The control method according to claim 10,
wherein the service is a service related to maintenance of the network device.

18. The control method according to claim 17,
wherein the maintenance information includes error information of the network device, a usage state of a consumable in the network device, the number of printed pages in the network device, and actual result information of maintenance action for the network device, and
wherein a simulation target includes at least one item of information about a utilization rate of the network device, a maintenance work count or time of a serviceman for the network device, and information related to inventory of consumables of the network device.
